(19) United States
(12) Patent Application Publication
(10) Pub. No.: US 2018/0069767 A1
(43) Pub. Date: Mar. 8, 2018

(54) PRESERVING QUALITY OF SERVICE CONSTRAINTS IN HETEROGENEOUS PROCESSING SYSTEMS

(71) Applicant: Advanced Micro Devices, Inc., Sunnyvale, CA (US)

(72) Inventors: Arkaprava Basu, Austin, TX (US); Joseph L. Greathouse, Austin, TX (US); Guru Prasadh V. Venkataramani, Fairfax, VA (US); Jan Vesely, Austin, TX (US)

(73) Assignee: Advanced Micro Devices, Inc., Sunnyvale, CA (US)

(21) Appl. No.: 15/257,286

(22) Filed: Sep. 6, 2016

(51) Int. Cl. H04L 12/24; H04L 29/08; G06F 12/0817; G06F 9/50

(52) U.S. Cl. CPC H04L 41/50; H04L 41/12; G06F 2212/621; G06F 12/0828; G06F 9/5005; H04L 67/32

(57) ABSTRACT

Techniques described herein improve processor performance in situations where a large number of system service requests are being received from other devices. More specifically, upon detecting that certain operating conditions that indicate a processor slowdown are present, the processor performs one or more system service adjustment techniques. These techniques include throttling (reducing the rate of handling) of such requests, coalescing (grouping multiple requests into a single group) the requests, disabling microarchitctural structures (such as caches or branch prediction units) or updates to those structures, and prefetching data for or pre-performing these requests. Each of these adjustment techniques helps to reduce the number of and/or workload associated with servicing requests for system services.

### STATEMENT REGARDING FEDERALLY SPONSORED RESEARCH OR DEVELOPMENT

This invention was made with Government support under (FastForward-2 Node Architecture (NA) Project with Lawrence Livermore National Laboratory (Prime Contract No. DE-AC52-07NA27344, Subcontract No. B609201) awarded by DOE. The Government has certain rights in this invention.

### BACKGROUND

Computer systems include a microprocessor that executes an operating system and also include other computer devices coupled to the microprocessor. When the other devices request the operating system to perform system services, the microprocessor performs a context switch to the operating system context and then services the request. Context switches are associated with computer performance slowdowns for a variety of reasons. Servicing system service requests may therefore result in an undesirable degree of microprocessor slowdown and a resultant loss in overall performance.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more disclosed embodiments are implemented;

FIG. 2A illustrates a technique for throttling system service requests, according to an example;

FIG. 2B illustrates a technique for coalescing system service requests, according to an example;

FIG. 2C illustrates a technique for disabling microarchitectural structures, or updates to those structures, according to an example;

FIG. 2D illustrates a technique for prefetching data (or pre-performing work) to prevent generation of system service requests by an accelerator, according to an example; and

FIG. 3 is a flow diagram of a method for performing one or more techniques for improving processor performance, according to an example.

### DETAILED DESCRIPTION

Techniques described herein improve processor performance in situations where a large number of system service requests are being received from other devices. More specifically, upon detecting that certain operating conditions that indicate a processor slowdown are present, the processor performs one or more system service adjustment techniques. These techniques include throttling (reducing the rate of handling) of such requests, coalescing (grouping multiple requests into a single group) the requests, disabling microarchitctural structures (such as caches or branch prediction units) or updates to those structures, and prefetching data for, or pre-performing, these requests. Each of these adjustment techniques helps to reduce the number of requests and/or the workload associated with servicing the requests for system services.

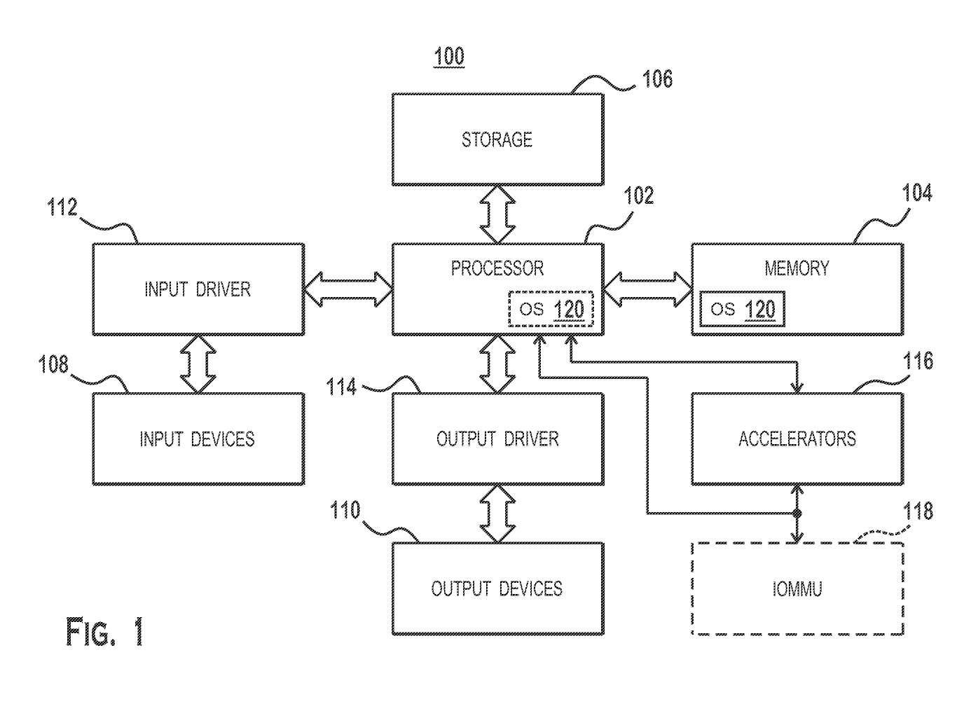

FIG. 1 is a block diagram of an example device 100 in which aspects of the present disclosure are implemented. The device 100 includes, for example, a computer, a gaming device, a handheld device, a set-top box, a television, a mobile phone, or a tablet computer. The device 100 includes a processor 102, a memory 104, a storage device 106, one or more input devices 108, and one or more output devices 110. The device 100 may also optionally include an input driver 112 and an output driver 114. It is understood that the device 100 may include additional components not shown in FIG. 1.

The processor 102 includes a central processing unit (CPU), a graphics processing unit (GPU), a CPU and GPU located on the same die, or one or more processor cores, wherein each processor core is a CPU or a GPU. The memory 104 may be located on the same die as the processor 102, or may be located separately from the processor 102. The memory 104 includes a volatile or non-volatile memory, for example, random access memory (RAM), dynamic RAM, or a cache. The processor 102 executes an operating system 120 which is stored at least partially in memory 104. The operating system 120 manages various aspects of operation of the computer system (e.g., multi-tasking, networking, memory management, file system management, security, hardware management) and provides a programmatic interface between user-level software and hardware. Part of the role of the operating system is to satisfy system service requests received from various sources, including user-mode applications and hardware devices.

The storage device 106 includes a fixed or removable storage, for example, a hard disk drive, a solid state drive, an optical disk, or a flash drive. The input devices 108 include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

The device 100 also includes one or more accelerators 116. The accelerators 116 include one or more electronic devices that perform computing operations at least partially at the request of the processor 102, acting on behalf of the operating system 120 or other software executing in the processor 102. Optionally, the processor 102 and accelerators 116 together form a heterogeneous system architecture. A heterogeneous system architecture is an aggregated computer platform in which multiple heterogeneous processors cooperate to execute software. According to various examples, the accelerators 116 include one or more of a graphics processing unit, an application specific integrated circuit (“ASIC”), which include non-programmable hard-wired components configured to perform a certain function, a field programmable gate array (“FPGAs”), which includes configurable elements out of which circuits having different functionality may be built, image processors, audio decoders and other media engines, cryptography engines, signal processors, and other types of processors such as accelerators for web search, computer vision, machine learning, databases, and graph analytics. Optionally, the device 100 also includes an input/output memory management unit (“IOMMU”) 118. The IOMMU performs virtual-to-physical memory address translations for the accelerators 116.

Due to the application-specific nature of the accelerators 116, certain operating system operations (also referred to as “system services”) can only be performed by the processor 102. According to various examples, such operations include handling page faults, file system access, networking operations, signaling other software processes, performing I/O to devices (such as other devices 100, input devices 108, and output devices 110), forking new software processing, setting or getting system time and date, learning about other hardware in the system, launching tasks to hardware, allocating and freeing memory, and other examples. In one example, the OS 120 handles page faults triggered as a result of an attempt at a virtual-to-physical memory address translation in the IOMMU 118.

An increase in activity in an accelerator or an increase in the number of accelerators in a device 100 sometimes results in an increase in the rate of generation of system requests for the device 100 as a whole. As the rate of generation of system service requests increases, the processor 102 experiences greater and greater processing loads related to those system requests. Increased processing loads result in certain effects that have a negative impact on other work the processor 102 is performing.

In one example, the increased number of system service requests results in an increase in total processing time spent satisfying requests. Typically, the processor 102 performs at least some amount of work responsive to an accelerator 116 sending a system service request to the processor 102 for processing. This work includes at least receiving the request and acknowledging the request, as well as performing the system service requested. Thus, an increased number of system requests results in an increase in the amount of time that the processor 102 consumes to perform those requests, resulting in a slowdown in other work due to less processor time being available for that other work.

In another example, some system service requests generate interrupts to inform the processor 102 that a system service request is to be processed. Such interrupts often cause the processor 102 to switch contexts from a user context to the operating system context, which causes slowdowns. For example, context switching results in overhead associated with saving the values of registers and other process-related state, and operations associated with transferring control to the operating system 120 and back to an executing application. These operations consume processing time that could be used for other work.

In yet another example, the act of servicing requests causes various microarchitectural structures to be “polluted” with data from the operating system 120. Microarchitectural structures include structures used for performance optimization, such as data and instruction caches and branch prediction units, and may also include other hardware structures that store state related to execution of software, including related to optimizing performance of the software. Pollution of microarchitectural structures often results in a slowdown in execution of other software (such as the user-mode application associated with the accelerator from which the system service request was received). For example, cache pollution results in an increased number of cache misses, which results in increased memory access latency. Pollution of branch prediction structures results in an increased rate of branch misprediction, with associated slowdowns in execution time related to the need to cancel the results of speculatively executed instructions and flush and refill the computing pipeline. Other microarchitectural structures may be polluted as well, resulting in other execution slowdowns.

In still another example, servicing system requests may also cause a processor 102 that is sleeping to be woken up, resulting in increased power consumption. More specifically, in some instances, a processor 102 that would execute an operating system 120 is placed into a reduced-power sleep mode when not needed. Waking that processor up to perform system services increases the overall power consumed by that processor 102.

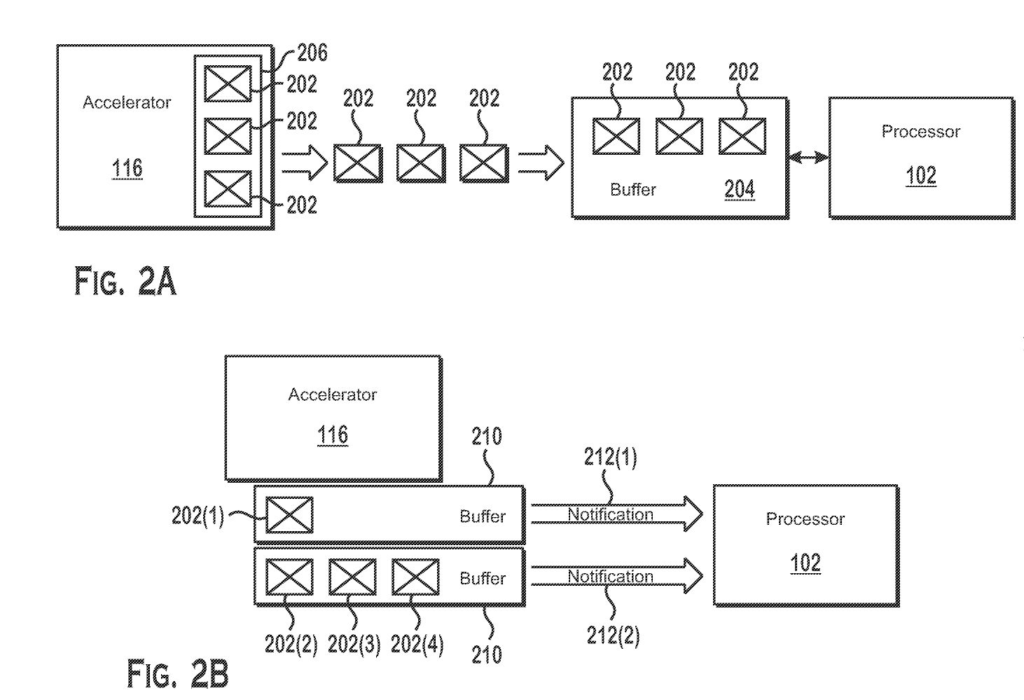

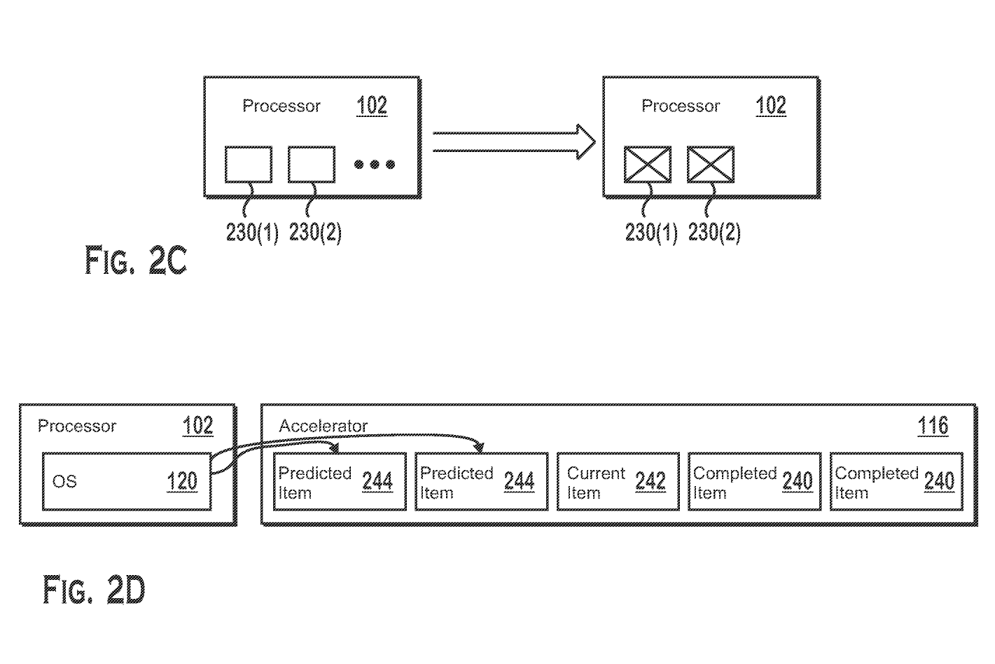

Various techniques are therefore provided herein to help prevent the above slowdowns. Such techniques include throttling system service requests, coalescing system service requests, disabling microarchitectural structures or updates to those structures while servicing system service requests, and prefetching. In one approach, these techniques are “turned on” and “turned off,” or the degree to which these techniques are applied is modified, based on various operational parameters of the device 100. These techniques are described below with respect to FIGS. 2A-2D.

FIG. 2A illustrates a technique for throttling system service requests, according to an example. As stated above, an accelerator 116 (or other hardware unit) transmits system service requests 202 to the processor 102 for processing. The requests 202 are stored in a buffer 204, which, in some examples, is a portion of system memory 104. At some point, the processor 102 wakes up a handler process that examines the request 202 transmitted to the processor 102 and handles the request.

The throttling technique involves slowing down the rate at which incoming requests for system services are handled. Instead of handling request on demand (e.g., as soon as the processor 102 is able), the processor 102 delays the handling of such requests. More specifically, the processor 102 waits some amount of time after receiving the request to process the request, and does not simply process the request when it is able to, or at a time that such requests would be processed without such an “artificial” slowdown. This delay has the effect of slowing down issuance of such requests by the accelerator 116. More specifically, accelerators 116 typically tolerate only a limited number of outstanding system service requests 206 before being forced to “stall,” or stop forward progress being made in the accelerator 116. For example, accelerators 116 may have a fairly limited set of hardware elements (such as registers that store system request identifiers or the like) that store data for outstanding system requests. When any of these hardware elements is exhausted, the accelerator 116 cannot proceed and therefore stalls. Thus, slowing down handling of system requests from accelerators 116 slows down execution of the accelerator 116.

The purpose of slowing down any particular accelerator 116 is to slow down the rate at which such accelerator 116 generates system requests. By slowing down this rate, the processor 102 receives fewer such requests, resulting in fewer context switches to the context of the operating system 120, thereby resulting in less slowdown associated with such context switches. The drawback of throttling system service requests is that the accelerator 116 is slowed down. Thus, the processor 102 balances the beneficial effect to the processor of throttling with the detrimental effect to the accelerator 116 (and associated workloads) of throttling. This balancing is done by monitoring certain operational parameters and making a determination of when to perform throttling and to what degree (e.g., how much to slow down processing of received requests 202) based on the monitored operational parameters. As described in further detail below, any monitored operational parameter may be used to determine whether to switch on or off throttling or to determine the degree to which throttling is applied.

In one example, the system request that is throttled is a request to handle a page fault generated as a result of a page fault in the IOMMU 118. More specifically, the IOMMU 118 receives requests to access system memory 104 from accelerators 116 and translates addresses within those requests to physical addresses for system memory 104. In some situations, however, a page fault occurs. In one example, a page fault occurs responsive to the IOMMU 118 being unable to perform a requested translation. Such a situation may occur when no such translation exists, for example, or when a page is not present in system memory 104 and must be fetched from storage 106. In another example, a page fault occurs responsive to an accelerator 116 attempting to perform an access type that the accelerator 116 is not permitted to perform. In this example, a page table may indicate that a particular page cannot be written to by an accelerator 116. If the accelerator 116 attempts to write to that page, then a page fault occurs.

In the event that a page fault occurs, either the IOMMU 118 or an accelerator 116 requests the processor 102 to handle the page fault by performing an appropriate system service. Thus, a request to handle a page fault in the IOMMU 118 is an example of a system service request. The processor 102 is capable of throttling requests to handle page faults, just like any other system service request.

FIG. 2B illustrates a technique for coalescing system service requests 202, according to an example. The coalescing technique involves grouping together a collection of system service requests 202 before notifying the processor 102 that there are system service requests 202 ready for processing. In one example, an accelerator 116 performs the coalescing technique. In another example, another hardware unit that is not the processor 102 or an accelerator 116 (such as the IOMMU 118) performs the coalescing technique.

In one example, coalescing is performed by grouping together multiple system service requests 202 and only notifying the processor 102 that system service requests 202 are ready for processing after the system service requests are grouped together. Typically, a hardware unit writes a notification into a buffer 210 and then sends a notification to the processor 102 that a system service request 202 is ready for processing. Instead of sending a notification after writing a single system service request 202 to the buffer 210, coalescing involves waiting either for a certain number of system service requests 202 to be written to the buffer 210 or waiting a certain amount of time after writing the system service request 202 to the buffer 210 before sending a notification to the processor 102 that a system service request is ready for processing (or waiting for either of those conditions to occur).

In the example illustrated in FIG. 2B, both a single request, non-coalescing technique and a coalescing technique are shown. Without coalescing, the accelerator 116 writes a single request 202(1) to buffer 210 and sends a notification 212(1) to the processor 102 that the request 202(1) is ready to be processed. With coalescing, the accelerator writes request 202(2), request 202(3), and request 202(4) into buffer 210 and sends a notification 212(2) after writing request 202(4) into the buffer 210. The buffer 210 is any memory space accessible to the accelerator 116 (or other hardware unit generating the system service request 202) and to the processor 102, and may be a portion of system memory 104.

In one example, the system service requests 202 to be coalesced are requests to handle page faults. An accelerator 116 generates a request to access memory that requires address translation. The IOMMU 118 receives that request and attempts to perform the translation. The IOMMU 118 detects that a page fault occurs. Either the IOMMU 118 or the accelerator 116 generates a request to handle the page fault and stores the request in a buffer. The accelerator 116 triggers additional page faults, which are also written to the buffer. After a threshold number of page faults have been written or a threshold amount of time has elapsed since the first page fault was written, the accelerator 116 or IOMMU 118 generates an interrupt and transmits the interrupt to the processor 102. (As is generally known, interrupts comprise signals detected by processors, such as processor 102, that interrupt current activity of the processor and require “handling” of whatever payload data, such as an error code or the like, that the interrupt is associated with). Upon receiving the interrupt, the processor 102 processes each of the page faults that have been written to the buffer. Because only a single interrupt was sent for multiple page faults, the processor 102 experiences less interrupt-related overhead related to context switching and the like.

FIG. 2C illustrates a technique for disabling microarchitectural structures, or disabling updates to those structures, according to an example. The processor 102 includes several microarchitectural structures 230 that help with performance. Examples of microarchitectural structures 230 include branch prediction units, caches, and the like. A branch prediction unit predicts the existence, outcome, and destination of branch instructions to prevent slowdowns associated with executing branches in a non-predictive manner. Branch prediction units may, however, predict an aspect of a branch instruction incorrectly, resulting in a branch misprediction. Branch mispredictions are associated with significant slowdowns in processor execution speed due to the need to “rewind” execution and flush the execution pipeline. Thus, high branch prediction accuracy is an important factor in processor performance. Caches are memory structures that store a subset of the contents of system memory 104. Accessing contents of a cache is faster than accessing the contents of system memory 104. Thus it is beneficial to store data or instructions that are predicted to be used in the near future in the cache. Requesting data or instructions not present in the cache results in a cache miss, with a resultant slowdown in processor operations. Reducing cache misses therefore helps with overall processor performance.

As described above, servicing system service requests causes a context switch in which the processor 102 stops executing some workload in order to execute the system service request handler (where the term “handler” refers to the portion of the operating system that services or “handles” requests for system services). This context switch and subsequent execution of the system service request handler results in population of microarchitectural structures with data associated with the system service request handler. Because the microarchitectural structures have limited memory space, execution of the system service request handler deletes some data associated with whatever workload was pre-empted by the system service request handler. When that workload resumes executing, the microarchitectural data that was overwritten is no longer available to help speed up that workload. This loss of microarchitectural state data thus causes a slowdown in execution of the workload. Too-frequent execution of system service request handlers can therefore result in a dramatic slowdown in performance of the processor 102.

Upon receiving an appropriate instruction or detecting modification to an appropriate configuration register, the processor 102 has the capability to not use the speed-ups provided by one or more microarchitectural structures. In one example, the processor 102 completely disables one or more microarchitectural structures upon entering a particular system service request handler. No speed-ups would be provided during execution of that handler, but the microarchitectural structures would also not be polluted with respect to the workload interrupted by the handler. Thus, when that workload resumes processing, the workload would not experience slowdowns associated with such pollution. In another example, the processor 102 only disables updates to one or more microarchitectural structures, but still uses whatever data is currently stored in the microarchitectural structures to perform appropriate speed-up services (e.g., still uses the branch prediction data for branch prediction and/or still uses data in the cache to improve memory access latency). For example, the processor 102 disables updates to global branch prediction history and/or to a branch target buffer of a branch prediction unit, or disables updates to an instruction cache or a data cache. In yet another example, the processor 102 entirely disables one or more microarchitectural structures and only disables updates to one or more other microarchitectural structures.

Disabling of at least one microarchitectural structure is illustrated in FIG. 2C. More specifically, on the left side of FIG. 2C, some microarchitectural structures 230 are illustrated as not disabled. The processor 102 transitions to the state illustrated in the right side of FIG. 2C, disabling several microarchitectural structures 230.

As with the techniques described above with respect to FIGS. 2A and 2B, one specific system service that triggers the microarchitecture disable technique of FIG. 2C is handling page faults generated as the result of operations in the IOMMU 118. The processor 102 is capable of partially disabling (e.g., disabling updates) or fully disabling one or more microarchitectural structures while servicing such page faults.

FIG. 2D illustrates a technique for prefetching data (or pre-performing work) to prevent generation of system service requests by an accelerator 116, according to an example. The processor 102 and operating system 120 are shown, as is the accelerator 116. The accelerator 116 processes various items. Several completed items 240, already processed by the accelerator 116, are shown. A current item 242 is also shown. The current item 242 is an item that is currently being processed by the accelerator 116. Predicted items 244 are also shown. Predicted items 244 are items predicted to be needed by the accelerator 116 but that have not yet been actually indicated as being needed by the accelerator 116. Each of the items represent units of work or data to be processed by an accelerator 116 that may trigger generation and sending of a request for system services to the processor 102. To help reduce the number of requests for system services being sent to the processor 102, the processor 102 predicts which items are needed by the accelerator 116 and makes those predicted items 244 available to the accelerator 116.

In one example, the items represent accesses to system memory, which trigger use of the IOMMU 118. In this example, a completed item 240 represents a memory access including a memory address translation that has been completed; a current item 242 represents a memory access and memory address translation that is current pending; and a predicted item 244 represents an address translation that the processor 102 predicts to be needed by the accelerator 116. More specifically, the predicted items 244 represent memory accesses that the processor 102 predicts would trigger a page fault in the IOMMU 118 if such memory accesses were not “pre-handled” by the processor 102.

In one example, pre-handling such memory accesses includes predicting which memory accesses that would cause page faults are likely to occur based on a history of memory accesses and performing actions to “pre-handle” those page faults. In one example, after receiving a request to handle a page fault for a first page, the processor 102 handles the page fault for that page and pre-handles page faults for a number of subsequent pages. The assumption for this prediction technique is that an accelerator 116 that accesses a first page is likely to access subsequent pages. This assumption is valid in some situations but might not be valid in others. In other examples, the processor 102 handles the page fault that is requested to be handled and additional page faults that are not directly subsequent to the page fault.

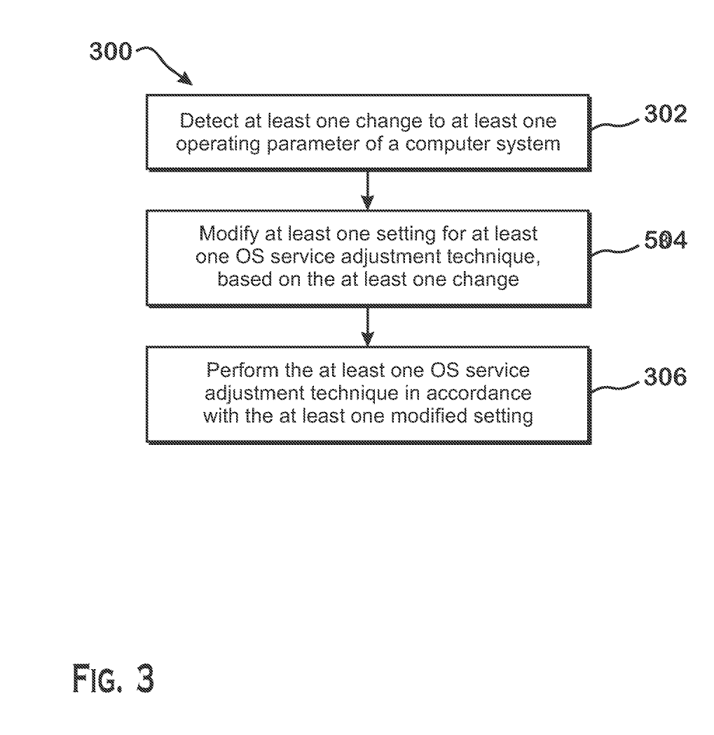

FIG. 3 is a flow diagram of a method 300 for performing one or more techniques for improving processor performance under a large load of system service requests, according to an example. Although described with respect to the system shown and described with respect to FIGS. 1 and 2A-2D, it should be understood that any system configured to perform the method, in any technically feasible order, falls within the scope of the present disclosure.

As shown, method 300 starts at step 302, where the processor 102 detects at least one change to an operational parameter. As described above, operational parameters are monitored to determine whether to perform the above techniques (i.e., when to switch the above techniques on or off) and also to determine the intensity with which the above techniques are performed. In various examples, operational parameters for monitoring include the amount of time the processor 102 spends in the handler for a system service request, the rate of data cache misses, the rate of instruction cache misses, the branch misprediction rate, the rate with which requests are received, the number of system service requests seen in a period of time, the estimated overhead of system service requests, user-defined parameters such as desired overhead, power and thermal information, desired frequency, application-level performance information, and other parameters.

At step 304, the processor 102 modifies at least one setting for at least one OS service adjustment technique. The “OS service adjustment techniques” refer to the techniques described above with respect to FIGS. 2A-2D, including throttling, coalescing, disabling microarchitectural states, and prefetching. In various examples, modifying a setting includes one or more of: switching the technique on, switching the technique off, increasing the intensity of the technique, or decreasing the intensity of the technique.

Switching throttling on or off means the processor 102 starts or stops throttling system service requests. Increasing or decreasing the intensity or throttling means that the processor 102 increases or decreases the delay between receiving and handling a system service request, respectively. Switching coalescing on or off means instructing the unit that actually performs coalescing (e.g., the IOMMU 118 or an accelerator 116) to begin or stop coalescing. Increasing the intensity of coalescing means increasing the window of time in which system service requests are coalesced, increasing the number of system service requests that are to be coalesced, or both. Decreasing the intensity of coalescing means decreasing the window of time in which system service requests are coalesced, decreasing the number of system service requests that are to be coalesced, or both. Switching microarchitectural structure disable on or off means turning aspects of one or more microarchitectural structures off or on, respectively. Switching prefetching on or off means beginning prefetching of items or stopping prefetching of items, respectively. Increasing or decreasing the intensity of prefetching means increasing the number of items that are prefetched or decreasing the number of items that are prefetched, respectively.

In some examples, the processor 102 maintains sets of operating parameters for each accelerator 116. In some examples, the processor 102 maintains sets of parameters for each system request. In some examples, the processor maintains sets of parameters for each combination of accelerator 116 and system request. In some examples, the processor 102 modifies the settings for each of the above techniques based on the particularity with which the processor 102 maintains operating parameters. For example, if the processor 102 stores operating parameters on a per-accelerator basis, then the processor maintains settings on a per-accelerator basis. Thus, techniques can be switched on or switched off, or applied at different levels of intensity, on a per-accelerator basis. In another example, if the processor 102 stores operating parameters on a per-system request basis, then the processor maintains settings on a per-system request basis. In a further example, if the processor 102 stores operating parameters on a per-system request, per-accelerator basis, then the processor 102 maintains settings on a per-system request and per-accelerator basis.

As described above, the processor 102 modifies the settings for the techniques based on the operating parameters. In various examples, the processor 102 turns on one or more techniques when one or more operating parameters are above respective turn-on thresholds. The turn-on thresholds comprise parameter values deemed to trigger turning on one or more of the techniques. The thresholds can be pre-set (for example, hard-coded) or can be modified dynamically based on operating conditions of the device 100.

In various examples, the processor 102 turns off one or more techniques when one or more operating parameters are below respective turn-off thresholds. As with the turn-on thresholds, the turn-off thresholds comprise parameter values deemed to trigger turning off one or more techniques and can be pre-set or dynamically modified based on operating conditions of the device.

In various examples, the processor 102 increases or decreases the intensity of any particular technique based on the difference between a current operating parameter and one of the thresholds. In one example, the degree with which the processor 102 increases the intensity of a particular technique varies linearly with the difference between a particular measure and a threshold. In another example, this degree varies exponentially. In various examples, the processor 102 uses other more complicated calculations to determine the intensity that a particular technique should be performed with.

At step 306, the processor 102 performs the at least one operating system service adjustment technique (i.e., throttling, coalescing, disabling microarchitectural structures, and prefetching) in accordance with the at least one modified setting.

Any of the actions described above as being performed by the processor 102 can be considered to be performed by an operating system, hypervisor, firmware, or by other software executing on the processor 102 or on behalf of the processor 102.

The techniques described herein improve processor performance in situations where a large number of system service requests are being received from other devices. More specifically, upon detecting that certain operating conditions that indicate a processor slowdown are present, the processor performs one or more system service adjustment techniques. These techniques include throttling handling of such requests, coalescing the requests, disabling microarchitctural structures or updates to those structures, and prefetching data for these requests. Each of these techniques helps to reduce the number of and/or workload associated with servicing requests for system services.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for reducing processing overhead in a processor of a computer system, the processor executing an operating system, the processing overhead associated with processing system service requests by the operating system and received from one or more accelerators external to the processor, the method comprising:
detecting at least one change in an operating parameter of the computer system, the operating parameter being related to the processing overhead associated with processing system service requests;
responsive to detecting the at least one change, modifying at least one setting for at least one technique for reducing the processing overhead; and
performing the at least one technique to reduce processing overhead in accordance with the at least one modified setting.

2. The method of claim 1, wherein:
performing the at least one technique comprises disabling at least a portion of a microarchitectural structure of the processor.

3. The method of claim 1, wherein:
performing the at least one technique comprises throttling the system service requests by adding artificial delay between when the processor is notified of system service requests and when the processor processes the system service requests, the artificial delay being in addition to delay that normally occurs between being notified of and processing system service requests.

4. The method of claim 1, wherein:
performing the at least one technique comprises coalescing the system service requests by grouping multiple system service requests together before notifying the processor that system service requests are available for processing.

5. The method of claim 1, wherein:
performing the at least one technique comprises prefetching at least one item for an accelerator to prevent the accelerator from generating at least one system service request.

6. The method of claim 1, wherein the at least one change in the operating parameter comprises one of an increase or a decrease in a rate of generation of system service requests.

7. The method of claim 1, wherein the at least one change in the operating parameter comprises one of an increase or a decrease in a cache miss rate.

8. The method of claim 1, wherein the at least one change in the operating parameter comprises one of an increase or a decrease in a misprediction rate of a processor predictor.

9. The method of claim 1, wherein the at least one change in the operating parameter comprises one of an increase or a decrease in an amount of time with which the processor executes handlers for processing system service requests.

10. A computing system, comprising:
one or more processing accelerators; and
a processor coupled to the one or more processing accelerators, wherein the processor is configured to:
detect at least one change in an operating parameter of the computing system;
responsive to detecting the at least one change, modify a setting for at least one technique for reducing the processing overhead associated with processing system service requests received from at least one of the one or more accelerators; and
perform the at least one technique to reduce processing overhead associated with processing system service requests received from at least one of the one or more accelerators.

11. The computing system of claim 10, wherein:
performing the at least one technique comprises disabling at least a portion of a microarchitectural structure of the processor.

12. The computing system of claim 10, wherein:
performing the at least one technique comprises throttling the system service requests by adding artificial delay between when the processor is notified of system service requests and when the processor processes the system service requests, the artificial delay being in addition to delay that normally occurs between being notified of and processing system service requests.

13. The computing system of claim 10, wherein:
performing the at least one technique comprises coalescing the system service requests by grouping multiple system service requests together before notifying the processor that system service requests are available for processing.

14. The computing system of claim 10, wherein:
performing the at least one technique comprises prefetching at least one item for an accelerator to prevent the accelerator from generating at least one system service request.

15. The computing system of claim 10, wherein the at least one change in the operating parameter comprises one of an increase or a decrease in a rate of generation of system service requests.

16. The computing system of claim 10, wherein the at least one change in the operating parameter comprises one of an increase or a decrease in a cache miss rate.

17. The computing system of claim 10, wherein the at least one change in the operating parameter comprises one of an increase or a decrease in a misprediction rate of a processor predictor.

18. The computing system of claim 10, wherein the at least one change in the operating parameter comprises one of an increase or a decrease in an amount of time with which the processor executes handlers for processing system service requests.

19. A method for reducing processing overhead in a processor of a computer system, the processor executing an operating system, the processing overhead associated with processing requests to handle page faults by the operating system and received from one of an accelerator on an input/output memory management unit (“IOMMU”), the method comprising:
detecting at least one change in an operating parameter of the computer system, the operating parameter including one or more of a rate of receiving requests to handle page faults from either the IOMMU or an accelerator, an instruction cache miss rate, a data cache miss rate, a branch misprediction rate, and a percentage of time during which the processor handles requests to handle page faults;
responsive to detecting the at least one change, modifying at least one setting for at least one technique for reducing the processing overhead; and
performing the at least one technique to reduce processing overhead in accordance with the at least one modified setting.

20. The method of claim 19, wherein performing the at least one technique comprises:
one or more of disabling updates to one or more microarchitectural structures of the processor, and disabling operation of the one or more microarchitectural structures.
